(19) United States
(12) Patent Application Publication
(10) Pub. No.: US 2014/0121307 A1
(43) Pub. Date: May 1, 2014

(54) BLENDING LIGNIN WITH THERMOPLASTICS AND A COUPLING AGENT OR COMPATIBILIZER

(71) Applicant: Cyclewood Solutions, Inc., Fayetteville, AR (US)

(72) Inventors: Nhiem Cao, Fort Smith, AR (US); Kevin Oden, Fayetteville, AR (US)

(73) Assignee: CYCLEWOOD SOLUTIONS, INC., Fayetteville, AR (US)

(21) Appl. No.: 14/066,666

(22) Filed: Oct. 29, 2013

Related U.S. Application Data
(60) Provisional application No. 61/720,327, filed on Oct. 30, 2012.

(51) Int. Cl. C08L 23/06; C08L 23/12

(52) U.S. Cl. CPC C08L 23/06; C08L 23/12
USPC 524/73

(57) ABSTRACT

A composition is provided in one example embodiment and includes a modified lignin, a thermoplastic, and a compatibilizer. The modified lignin may be between about 5% to about 50% by weight of the composition. Also, the modified lignin may be a Hydroxypropyl Lignin (HPL). In an example, the thermoplastic can include a High Density Polyethylene (HDPE). In another example, the thermoplastic can include a Low Density Polyethylene (LDPE). In yet another example, the thermoplastic can include a Linear Low Density Polyethylene (LLDPE). The compatibilizer may be a Maleic Anhydride grafted Polyethylene Blend (MAh-g-PE).

### CROSS-REFERENCE TO RELATED APPLICATION

This application claims the benefit of priority under 35 U.S.C. §119(e) to U.S. Provisional Application Ser, No. 61/720,327, entitled “BLENDING LIGNIN WITH THERMOPLASTICS AND A COUPLING AGENT OR COMPATIBILIZER” filed on Oct, 30, 2012, which is hereby incorporated by reference in its entirety.

### TECHNICAL FIELD

This disclosure relates in general to the field of compositions and, more particularly, to blending lignin with thermoplastics and a coupling agent or compatibilizer.

### BACKGROUND

Processibility and compatibility of wood flour with polymers are two major technical obstacles faced by processors and equipment suppliers while developing wood plastic composites. Wood plastic composites offer performance advantages such as better flexural and impact strength, better moisture resistance, less shrinkage, and improved weatherability. A key element behind these improvements is the additives incorporated into wood-filled plastic formulations. One important group of additives are coupling agents or compatibilizers. Coupling agents are chemicals that enhance the compatibility of nonpolar plastic resin molecules with highly polar cellulosic wood fillers. In addition to aiding in the dispersion of wood fillers, coupling agents or compatibilizers can help transfer the inherent strength of cellulosic wood fibers to the surrounding plastic by improving the bonding between cellulose molecules and hydrocarbon-based polymers.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a flowchart illustrating potential operations associated with blending lignin with thermoplastics and a coupling agent or compatibilizer in accordance with one embodiment of the present disclosure.

### DETAILED DESCRIPTION OF EXAMPLE EMBODIMENTS

### Overview

A composition is provided in one example embodiment and includes a modified lignin, a thermoplastic, and a compatibilizer. The modified lignin may be between about 5% to about 50% by weight of the composition. Also, the modified lignin may be a Hydroxypropyl Lignin (HPL). In an example, the thermoplastic can include a High Density Polyethylene (HDPE). In another example, the thermoplastic can include a Low Density Polyethylene (LDPE). In yet another example, the thermoplastic can include a Linear Low Density Polyethylene (LLDPE).

The compatibilizer may be a Maleic Anhydride grafted Polyethylene Blend (MAh-g-PE). In addition, the compatibilizer may be a branched, block or grafted copolymer that is formed during a reactive blending process. Also, the composition may be created using coupling agents.

In a specific implementation, the compatibilizer is a reactive polymer and during formation of the composition, the reactive polymer is miscible with the thermoplastic and reactive towards functional groups attached to the modified lignin which results in an in-situ formation of block or grafted copolymers. Also, the modified lignin may be blended with a polyethylene (PE) thermoplastic and a grafted PE functioning as a lignin compatibilizer. In a specific example, the composition includes about 45% by weight of the modified lignin, about 50% by weight of the PE thermoplastic, and about 5% by weight of the PE grafted lignin compatibilizer. In one instance, the modified lignin is a transesterified lignin. Further, the compatibilizer may activate inert polyolefins and result in the formation of branched copolymers in the modified lignin. In addition, the compatibilizer may include a peroxide and a bifunctional chemical that results in the formation of the branch copolymers.

### Example Embodiments

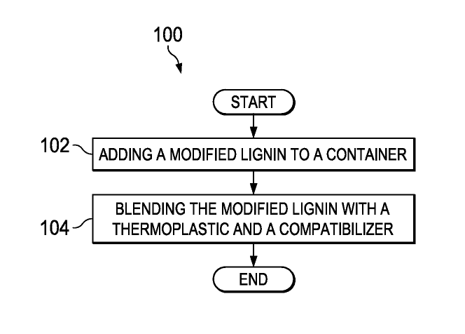

Turning to FIG. 1, FIG. 1 is a simplified flowchart 100 illustrating example activities in accordance with one embodiment of the present disclosure. 102 includes adding a modified lignin to a container. 104 includes blending the modified lignin with a thermoplastic and a compatibilizer.

For purposes of illustrating certain example techniques of the present disclosure, the following foundational information may be viewed as a basis from which the present disclosure may be properly explained. Lignin, a natural polymer found in wood, is a polyaromatic polyol that is readily available and relatively inexpensive. Lignin exists in plant cell walls, and its amount in overall natural abundance is only less than that of cellulose. Enormous amounts of lignin are produced as byproducts of papermaking. The structure of lignin is typically dependent on the wood species and processing conditions. Ordinarily, the lignin macromolecular structure is chemically complex and the main monomer units constituting lignin molecules are 2-methoxy-4-propylphenol (guaiacol) in softwood and a mixture of guaiacol and 3,5-dimethoxy-4-propylphenol (syringol) in hardwood. In order for lignin to gain wider utilization as an inexpensive and biodegradable/biorenewable material, blends of lignin with thermoplastics are needed with enhanced mechanical and other useful properties. These enhanced properties should exceed those properties predictable by simple rules of mixing of the corresponding blends.

The term ‘thermoplastic’ in the contexts discussed herein is meant to be broad and encompass any suitable polymer, composite, blend, material, etc. For example, the thermoplastic polymer may become pliable or moldable above a specific temperature. Further, certain example polymers may return to a solid state upon cooling. Most thermoplastics have a high molecular weight, whose chains associate through intermolecular forces; this property allows thermoplastics to be remolded because the intermolecular interactions (e.g., spontaneously) reform upon cooling. The term ‘thermoplastics’ as used herein can also include thermosetting polymers and thermoset bonds. Such thermoplastic materials can be available in many different forms (e.g., at different molecular weights), which might have quite different physical properties. The thermoplastics can be referred to by many different tradenames, by different abbreviations and/or include two or more chemical compounds.

Coupling agents are additives that increase the interaction of one material with another. The usual coupling action is based on primary or secondary chemical bonds and is particularly useful in coupling fillers or fibers to a polymeric matrix. Examples of coupling agents include silanes, titanates, zirconates and aluminumates. Coupling agents may promote adhesion, catalyze reactions, improve dispersion, rheology, impact strength, prevent phase separation, and inhibit corrosion. Coupling agents may also involve six functions, hydrolysis coupling reactions, catalyzed reactions, functional groups, thermoplastic functions, crosslinking functions, and mixed functions.

A compatibilizer is any interfacial agent or surfactant that facilitates formation of uniform blends of normally immiscible polymers with desirable end properties (i.e., promotes dissolution of one material in another). Usually the chains of a compatibilizer have a blocky structure, with one constitutive block miscible with one blend component and a second block miscible with another blend component. These blocky structures can be pre-made and added to an immiscible blend or they can be generated in-situ during the blending process. The latter procedure is called reactive compatibilization, and mutual reactivity of both blend components is appropriate. Compatibilizers are able to generate and stabilize a finer morphology.

The emulsification of polymer blends has been proposed as the most efficient tool for obtaining a fine phase morphology and good mechanical properties. One way to validate the concept is to tailor block and grafted copolymers to be changed in a systematic way, (e.g., molecular architecture, composition of molecular weight, etc.) so that basic relationships can be drawn between the structural characteristics of these additives and the general properties of the polyblends. These relationships can be used as desirable guidelines for the emulsification of polyblends.

The addition of a reactive polymer that is miscible with one blend component and reactive towards functional groups attached to a second blend component results in the in-situ formation of block or grafted copolymers. This technique has certain advantages over the addition of premade block or grafted copolymers. Usually reactive polymers can be generated by free radical copolymerization or by melt grafting of reactive groups onto chemically inert polymer chains. Furthermore, reactive polymers may only generate block or grafted copolymers at the site where they are needed (i.e., at the interface of an immiscible polymer blend). Although grafted, and especially block, copolymers may form micelles after being added to or formed in a blend, the chance that the critical micelle concentration is exceeded is actually higher in the case of pre-made structures. This is a drawback with respect to the efficiency of the compatibilizer. Also, the melt viscosity of a linear reactive polymer is lower than that of a pre-made block or grafted copolymer, at least if the blocks of the pre-made copolymer and the reactive blocks are of similar molecular weights. Lower molecular weight polymers will diffuse at a higher rate towards the interface. This is important in view of the short processing times used in reactive blending which may be on the order of a minute or less.

A completely different strategy for polymer blend compatibilization relies upon the addition of a (mixture of) low molecular weight chemical(s). The actual compatibilizer, a branched, block or grafted copolymer, can be formed during a reactive blending process. Various procedures may be distinguished, depending on the added chemical(s) (e.g. a peroxide, that activates inert polyolefins and results in the formation of branched copolymers, a bifunctional chemical that forms block copolymers, a mixture of a peroxide and a bifunctional chemical, which leads to the formation of branch/graft copolymers, etc.). Compatibilization can be achieved not by reducing the interfacial tension, but by locking in a thermodynamically non-equilibrium morphology. This is achieved by the addition of selective crosslinking agents may be reactive towards at least one of the blend components (i.e., dynamic vulcanization).

In a particular embodiment, a modified lignin may be blended with a polyethylene (PE) and a diblock compatibilizer such as a PE grafted lignin compatibilizer. [The term ‘lignin’ is meant to encompass a broad category of chemical compounds. For example, example chemical compounds may be derived from wood, secondary cell walls of plants, certain algae, etc. Any such materials are encompassed by the broad term lignin.] The diblock compatibilizer can increase the interfacial activities between the modified lignin and the PE. The PE portion of the compatibilizer can be miscible with the PE, while the lignin portion can be miscible with the modified lignin. In one example the blend may consist of about 45% modified lignin, about 50% PE, and about 5% PE grafted lignin compatibilizer.

In another embodiment, one chemical, (e.g., a peroxide) can be added to an incompatible blend. With a modified lignin/PE blend, it is believed that the radicals derived from the peroxide activate the chemically inert polyolefins via homolytic bonds breaking to generate radicals. In a next step, the modified lignin and PE macroradicals combine and form a branched modified lignin-PE copolymer, which acts as compatibilizer. In addition to this in-situ compatibilizer formation, the crosslinking of PE and/or the degradation of modified lignin also occurs. In addition, crystallization of the blend components can be affected.

Polymers used in wood plastic composites are mostly polyolefins such as PE (particularly HDPE). In an embodiment, polypropylene (PP) and maleated polyolefins may be used as coupling agents. Maleated polyolefins consist mostly of PE or PP with maleic anhydride functional groups grafted onto the polymer backbones. Grafting may be done with peroxide reagents reacting within polymer chains or at terminal olefinic groups. When the grafted polyolefins are melted with polymers of similar composition and then cooled, they may co-crystallize with the base polymers. Also, the maleic anhydride groups can react with the hydroxyl groups on the surface of cellulosic fibers to form strong covalent ester linkages. Maleated polyolefin additives are available in pellet form and can be added to standard extrusion or injection molding equipment. Other coupling agents employed in wood-plastic composites include organosilanes, fatty acid derivatives, long-chain chlorinated paraffins, and polyolefin copolymers with acid anhydrides incorporated into the polymer backbones (instead of grafted).

In an embodiment, a modified lignin may be blended between about 5% to about 50% total weight to thermoplastics and a coupling agent or compatibilizer. In one example, a blend may include 25% Hydroxypropyl Lignin (HPL), 73% High Density PE (HDPE), and 2% Maleic Anhydride grafted PE Blends (MAh-g-PE). In another example, the blend may include 35% HPL, 63% HDPE, and 2% MAh-g-PE. In yet another example, the blend may include 25% HPL, 73% PP, and 2% MAh-g-PP. In another example, the blend may include 63% PP, 35% HPL, and 2% MAh-g-PP. Mah-g-PE and MAh-g-PP are end reactive compatibilizers. The maleic anhydride end allows for reaction to form copolymers with the modified lignin. The PE and PP ends are miscible with the respective polymer component.

In a particular embodiment, the modified lignin is a transesterified lignin. Generally, transesterification is the process of exchanging the organic group R″ of an ester with the organic group R′ of an alcohol. The reaction can be catalyzed by the addition of an acid or base catalyst and can also be accomplished with the help of enzymes (biocatalysts) particularly lipases (E.C.3.1.1.3). For example, in the presence of an acid or base, a lower alcohol may be replaced by a higher alcohol by shifting the equilibrium (e.g., by using a large excess of the higher alcohol or by distilling off the lower alcohol). More specifically, as described herein, transesterification can include a method of enhancing the properties of materials that are comprised of lignin and blended with certain thermoplastics by means of a chemical reaction taking place between the two polymer components. Adding a compatibilizer, such as MAh-g-PE, to improve the tensile strength of the resulting product and to also limit the level of transesterification. Over-tranesterification may result in the formation of a thermoset, which limits the processibility of the resulting product. The compatibilizer may comprise up to 25% of the final product by weight.

In one example, a transesterified product may be comprised of chemically-modified lignin blended with a polyester. For example, transesterification of an acetoxypropyl lignin or a hydroxypropyl lignin may be used to produce a transesterified product. In another embodiment, an ester exchange may be used to produce the transesterified product. For example, an acetate ester of the lignin can be used to swap carboxylic acid groups with the alcohol oligomer units in the polyester chains and vice versa. The effect is to covalently-bond polyester oligomer units (long straight chains) to the lignin while some of the polyester chains would be shortened and terminated with acetate esters. Because the acetoxypropyl lignin has multiple available chemical functional groups, this exchange may happen multiple times.

In an embodiment, chemically-modified lignins may be chosen from hydroxyalkylated lignins (such as hydroxypropylated lignin) and/or acylated lignins (such as an acetate ester) or other lignin derived materials.

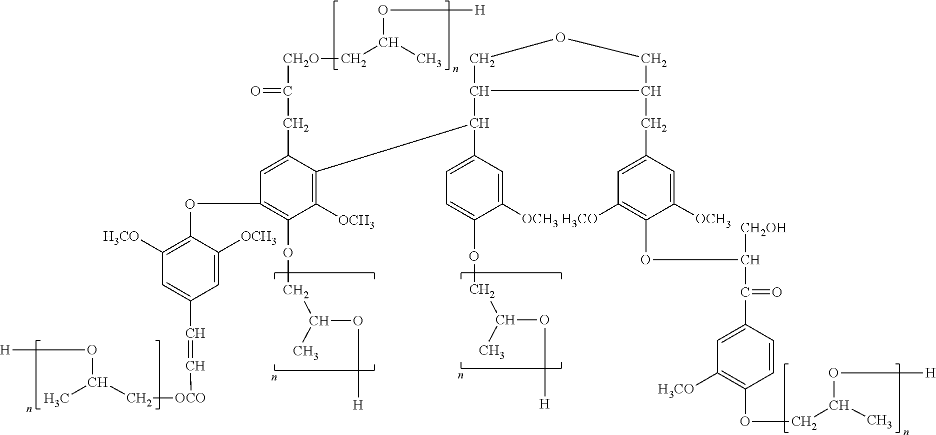

### HYDROXYPROPYL LIGNIN (HPL)

Where n=1

### ACETOXYPROPYL LIGNIN (APL)

Where all OH-groups are replaced by —O Acetyl (CO—CH₃) groups

In such blends of chemically-modified lignins with certain thermoplastics, transesterification may occur with the replacement of one alcohol group in the ester linkage by another alcohol group. Accordingly, a hydroxyalkylated lignin may undergo transesterification with a nearby polyester macromolecule, thereby transferring a segment of the polyester onto the lignin. In addition, transesterification (or ester exchange) may occur with an acylated lignin (or acylated and hydroxypropylated lignin). In this instance, an alkyl ester (such as an acetate ester) of the lignin may exchange carboxylic acid groups with an alcohol terminated segment of the polyester chain. The effect may be to covalently-bond long chain polyester segments to the lignin with concomitant changes in bulk properties.

The resulting enhanced properties in the transesterified lignin/thermoplastic blends can include increased tensile strength, increased modulus, increased compressive strength, decreased coefficient of thermal expansion, retarded biodegradability and other properties. It is important to note that it is desirable that the extent of transesterification of the lignin/thermoplastic blend be controlled or limited such that extensive crosslinking should not occur. Extensive crosslinking may decrease or prevent processibility of the lignin/thermoplastic blend (e.g., processibility into films, fibers or molded articles) and may result in a thermoset. The modified lignin, thermoplastic, and compatibilizer compositions discussed herein can be used, for example, in the field of plastics, biodegradable materials, etc. and, further, in the production of film products such as bags (e.g., grocery bags, trash bags, etc.), sheets, liners, agricultural films, packaging, etc.; formed and molded products such as cups and plates, cutlery, bottles etc.; injection molded products such as toys, flower pots, computer cases, automotive parts, etc.; extruded products such as pipes, hoses, tubing, etc., and various other consumer products.

### Example Embodiments—Lignin Chemical Modification Reactions

High Density PE (HDPE)/Hydroxypropyl Lignin (HPL)/Maleic Anhydride grafted PE Blends (MAh-g-PE)

Two blends of HDPE/HPL/MAh-g-PE were produced. One was composed of 73% HDPE, 25% HPL, and 2% MAh-g-PE. The other was composed of 63% HDPE, 35% HPL, and 2% MAh-g-PE. Approximately 7 pounds of each blend was produced using a Theysohn TSK 21 mm twin screw extruder. A water bath was used to cool the strand as it exited the extruder. Once cooled it was pelletized with a strand pelletizer. When films were pressed with a hot press, the films appeared to be uniform and homogeneous.

For each of the blends, the HDPE was added through the main feeder. The HPL and MAh-g-PE were pre-mixed and fed through a side feeder. The temperature zones throughout the extruder were maintained between 350° F. and 400° F.

PP/Hydroxypropyl Lignin (HPL)/Maleic Anhydride grafted PP Blends (MAh-g-PP)—

Two blends of PP/HPL/MAh-g-PP were produced. One was composed of 73% PP, 25% HPL, and 2% MAh-g-PP. The other was composed of 63% PP, 35% HPL, and 2% MAh-g-PP. Approximately 7 pounds of each blend was produced using a Theysohn TSK 21 mm twin screw extruder. A water bath was used to cool the strand as it exited the extruder. Once cooled it was pelletized with a strand pelletizer. When films were pressed with a hot press, the films appeared to be uniform and homogeneous.

For each of the blends the PP was added through the main feeder. The HPL and MAh-g-PP were pre-mixed and fed through a side feeder. The temperature zones throughout the extruder were maintained between 350° F. and 400° F.

One blend was produced with HPL, linear low density PE (LLDPE), and MAh-g-PE. The MAh-g-PE acted as a diblock compatibilizer. The composition of the blend was 45% HPL, 50% LLDPE, and 5% MAh-g-PE. Approximately 10 lbs of the blend was produced with the Theysohn TSK 21 mm twin screw extruder. The LLDPE was added through the main feeder. The HPL and PE grafted lignin were premixed and fed through the side feeder. The temperature zones throughout the extruder were maintained between 300° F. and 350° F. A water bath was used to cool the blended strand as it exited the extruder. Once cooled the strand was pelletized with a strand pelletizer. When films were pressed with a hot press, the films appeared to be uniform and homogeneous.

Another blend was produced with HPL, polystyrene (PS), and hydrogen peroxide. The hydrogen peroxide acted as a compatibilizer. The composition of the blend was 48% HPL, 50% PS, and 2% hydrogen peroxide. Approximately 10 lbs of the blend was produced with the Theysohn TSK 21 mm twin screw extruder. The PS was added through the main feeder. The HPL and hydrogen peroxide were premixed and fed through the side feeder. The temperature zones throughout the extruder were maintained between 300° F. and 350° F. A water bath was used to cool the blended strand as it exited the extruder. Once cooled the strand was pelletized with a strand pelletizer.

Compounding OS Lignin and MAh-g-PE at PCE

An organosolv Lignin (OSL) and polyethylene blend was produced using maleic anhydride grafted polyethylene (MAh-g-PE) as a compatibilizer. A polyethylene polymer blended with lignin was a low melt linear low density polyethylene (LLDPE). The OSL:LLDPE blending ratio was 15:85 with 1% MAh-g-PE and 0.25% slip agent. The blend was extruded on a Theysohn TSK 21 mm twin screw extruder. A carrier resin, LLDPE, was mixed with the MAh-g-PE pellets. The mixture was fed through a hopper, and OSL powder was mixed with the slip agent. This mixture was side fed about mid-way through the screw extruder. The compounded strand was cooled with 2 water baths and had an air knife to blow off excess water before being cut into pellets. The OSL:LLDPE blend with MAh-g-PE produced uniform pellets that ran nicely with good ventilation. Prior to blow extrusion, the resulting pellets were placed in a desiccant dryer overnight to reduce the moisture to below 0.5%. The pellets were blown on a 1.5″ single screw extruder with a 2″ vertical blown film air die. The OSL:LLDPE with MAh-g-PE blend produced a uniform film sample with a feel like conventional plastic films. It was discovered that the OSL can be successfully blended with a low melt LLDPE at a 15:85 ratio and 1% MAh-g-PE. Increasing the amount of MAh-g-PE can improve the blown film miscibility, such as 2%. The procedure illustrates that MAh-g-PE can help OSL blend with a low melt LLDPE to produce a blown film.

Note that many of the compositions, materials, percentages, etc. discussed herein could readily be changed, modified, altered, or substituted with different materials without departing from the teachings of the present disclosure. It is similarly imperative to note that the operations and steps described illustrate only some of the possible scenarios that may be executed by, or within, the systems of the present disclosure. Some of these operations may be deleted or removed where appropriate, or these steps may be modified or changed considerably without departing from the scope of the discussed concepts. In addition, the timing of these operations may be altered considerably and still achieve the results taught in this disclosure. The preceding discussions have been offered for purposes of example and discussion. Substantial flexibility is provided by the system in that any suitable arrangements, chronologies, configurations, and timing mechanisms may be provided without departing from the teachings of the discussed concepts. Along similar lines, the ranges (e.g., with respect to timing, temperature, concentrations, etc.) could be varied considerably without departing from the scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A composition comprising:
a modified lignin;
a thermoplastic; and
a compatibilizer.

2. The composition of claim 1, wherein the modified lignin is between about 5% to about 50% by weight of the composition.

3. The composition of claim 1, wherein the modified lignin is a Hydroxypropyl Lignin (HPL).

4. The composition of claim 1, wherein the thermoplastic includes a High Density Polyethylene (HDPE).

5. The composition of claim 1, wherein the thermoplastic includes a Low Density Polyethylene (LDPE).

6. The composition of claim 1, wherein the thermoplastic includes a Linear Low Density Polyethylene (LLDPE).

7. The composition of claim 1, wherein the compatibilizer is a Maleic Anhydride grafted Polyethylene Blend (MAh-g-PE).

8. The composition of claim 1, wherein the compatibilizer is a branched, block or grafted copolymer that is formed during a reactive blending process.

9. The composition of claim 1, wherein the composition is created using coupling agents.

10. The composition of claim 1, wherein the compatibilizer is a reactive polymer and during formation of the composition, the reactive polymer is miscible with the thermoplastic and reactive towards functional groups attached to the modified lignin which results in an in-situ formation of block or grafted copolymers.

11. The composition of claim 1, wherein the modified lignin is blended with a polyethylene (PE) thermoplastic and a grafted PE functioning as a lignin compatibilizer.

12. The composition of claim 9, wherein the composition includes about 45% by weight of the modified lignin, about 50% by weight of the PE thermoplastic, and about 5% by weight of the PE grafted lignin compatibilizer.

13. The composition of claim 1, wherein the modified lignin is a transesterified lignin.

14. The composition of claim 1, wherein the compatibilizer activates inert polyolefins and results in the formation of branched copolymers in the modified lignin.

15. The composition of claim 1, wherein the compatibilizer includes a peroxide and a bifunctional chemical that results in the formation of the branch copolymers.

16. A method comprising:
blending a modified lignin, a thermoplastic, and a compatibilizer.

17. The method of claim 16, wherein the modified lignin is between about 5% to about 50% by weight of the blended modified lignin, thermoplastic, and compatibilizer.

18. The method of claim 16, wherein the compatibilizer is a reactive polymer and during formation of the compound, the reactive polymer is miscible with the thermoplastic and reactive towards functional groups attached to the modified lignin which results in an in-situ formation of block or grafted copolymers.

19. A composition comprising:
a modified lignin, wherein the modified lignin is a transesterified lignin;
a thermoplastic; and
a compatibilizer.

20. The composition of claim 19, wherein the modified lignin is between about 5% to about 50% by weight of the compound.
